(19) United States
(12) Patent Application Publication
(10) Pub. No.: US 2023/0391666 A1
(43) Pub. Date: Dec. 7, 2023

(54) CHEMICALLY STRENGTHENED GLASS PRODUCTION METHOD AND CHEMICALLY STRENGTHENED GLASS

(71) Applicant: AGC Inc., Tokyo (JP)

(72) Inventors: Kaname SEKIYA, Tokyo (JP); Izuru KASHIMA, Tokyo (JP)

(73) Assignee: AGC Inc., Tokyo (JP)

(21) Appl. No.: 18/454,228

(22) Filed: Aug. 23, 2023

Related U.S. Application Data
(63) Continuation of application No. PCT/JP2022/008086, filed on Feb. 25, 2022.

(30) Foreign Application Priority Data
Feb. 26, 2021 (JP) 2021-030726
Jan. 21, 2022 (JP) 2022-008178

(51) Int. Cl. C03C 21/00; C03C 3/095; C03C 3/097; C03C 10/00

(52) U.S. Cl. CPC C03C 21/002; C03C 3/095; C03C 3/097; C03C 10/0027

(57) ABSTRACT

The present invention relate to a chemically strengthened glass manufacturing method for obtaining a chemically strengthened glass by performing an ion exchange treatment on a glass for chemical strengthening having a CTA value of x (MPa) obtained by Equation (1), the method including: a first ion exchange treatment of bringing a first molten salt composition into contact with the glass for chemical strengthening so that a CTave value, which is obtained by Equation (2), of the glass for chemical strengthening exceeds x (MPa); and a second ion exchange treatment, after the first ion exchange treatment, of bringing the glass for chemical strengthening into contact with a second molten salt composition having a component ratio different from a composition ratio of the first molten salt composition so that the CTave value of the glass for chemical strengthening is less than x (MPa).

### CROSS-REFERENCE TO RELATED APPLICATIONS

This is a continuation of International Application No. PCT/JP2022/008086 filed on February 2022, and claims priority from Japanese Patent Applications No. 2021-030726 filed on Feb. 26, 2021 and No. 2022-008178 filed on Jan. 21, 2021, and the entire contents of which are incorporated herein by reference.

### TECHNICAL FIELD

The present invention relates to a chemically strengthened glass manufacturing method and a chemically strengthened glass.

### BACKGROUND ART

A chemically strengthened glass is used for cover glasses or the like of portable terminals such as smartphones. The chemically strengthened glass is a glass in which a compressive stress layer is formed in a glass surface portion through an ion exchange treatment, in which a glass is brought into contact with a molten salt composition such as sodium nitrate and potassium nitrate. In the ion exchange treatment, ions are exchange between alkali metal ions contained in the glass and alkali metal ions having a larger ion radius contained in the molten salt composition, so that the compressive stress layer is formed in the glass surface portion. The strength of the chemically strengthened glass depends on a stress profile represented by a compressive stress (hereinafter may be abbreviated as “CS”) with the depth from the glass surface as a variable.

The cover glasses of portable terminals and the like may be broken by deformation that occurs when, for example, they are dropped. To prevent such breaking, that is, breaking due to bending, it is effective to increase the compressive stress at the glass surface. To this end, in recent years, it becomes common to produce a surface compressive stress of 700 MPa or larger.

The cover glasses of portable terminals and the like may also be broken by collision with a protrusion when they are dropped onto an asphalt surface or grit. To prevent such breaking, that is, breaking due to impact, it is effective to increase the strength by forming a compressive stress layer to a deeper portion of the glass by increasing the compressive stress layer depth.

However, in the case where the compressive stress layer is formed in a surface portion of a glass article, tensile stress (hereinafter may be abbreviated as “CT”) necessarily occurs in a core portion of the glass article according to a total amount of the compressive stress. In the case where the CT value is too large, a glass article is broken violently to scatter fragments. In the case where the CT value exceeds a threshold value (hereinafter referred to as “CT limit”), the number of fragments during the glass breaking starts to increase explosively. The CT limit is a specific value for a glass composition.

Therefore, in a chemically strengthened glass, while a surface compressive stress is set to be large and a compressive stress layer is formed to a deeper portion, the total amount of the surface compressive stress is determined so that the CT value does not exceed the CT limit. For example, Patent Literature 1 discloses a chemically strengthened glass in which CT is controlled so as to fall within a specific range.

One of indices for evaluating the strength of glass-based materials used in smartphones is a “set drop strength test”. The “set drop strength test” is a test of dropping a sample obtained by laminating a smartphone housing or a mock plate imitating a smartphone and a glass-based material, and using a drop height at which breaking occurs as the index of strength. The set drop strength is an index that can reflect the strength of the glass-based material when used as a product.

### CITATION LIST

### Patent Literature

Patent Literature 1: JP2017-523110A

### SUMMARY OF INVENTION

### Technical Problem

Since the chemically strengthened glass tends to break easily when the CT value exceeds the CT limit value, in the related art, the total amount of the surface layer compressive stress of the chemically strengthened glass is designed so that the CT limit value is not exceeded. Therefore, the strength of the chemically strengthened glass represented by the set drop strength is determined depending on the CT limit value, and there is a limit to the achievable set drop strength.

Accordingly, an object of the present invention is to provide a chemically strengthened glass manufacturing method and a chemically strengthened glass that exhibit a superior set drop strength in the art while avoiding the CT limit.

### Solution to Problem

The present inventors studied the above problems, found that the above problems can be solved by including a first ion exchange treatment that imparts a tensile stress exceeding a CT limit value of a glass material constituting a glass for chemical strengthening to the glass for chemical strengthening, and after the first ion exchange treatment, a second ion exchange treatment of reducing the tensile stress of the glass for chemical strengthening to less than the CT limit value, in a chemically strengthened glass manufacturing method, and completed the present invention.

The present invention relates to a chemically strengthened glass manufacturing method for obtaining a chemically strengthened glass by performing an ion exchange treatment on a glass for chemical strengthening having a CTA value of x (unit:MPa) obtained by Equation (1) shown below, the method including:

a first ion exchange treatment of bringing a first molten salt composition into contact with the glass for chemical strengthening so that a CTave value, which is obtained by Equation (2) shown below, of the glass for chemical strengthening exceeds x (unit:MPa); and

a second ion exchange treatment, after the first ion exchange treatment, of bringing the glass for chemical strengthening into contact with a second molten salt composition having a component ratio different from a composition ratio of the first molten salt composition so that the CTave value of the glass for chemical strengthening is less than x (unit:MPa).

[Eq. 1]

CTA=317.93×K1c/\sqrt{t}+228.5×t−398 Equation (1)

t: plate thickness (μm)

K1c: fracture toughness value (MPa·m^{1/2})

CTave=ICT/L_{cT} Equation (2)

ICT: integrated value (Pa·m) of tensile stress

L_{CT}: plate thickness direction length (μm) of tensile stress area

The present invention also relates to a chemically strengthened glass having a Z value represented by Equation (3) shown below that satisfies Inequation (4) shown below.

Z=(CS₃₀₋₆₀ integrated value/ICT) Equation (3)

Z>0.29×y³+0.00086×ln(y²)+0.0013×y−0.0213×t Inequation (4)

In Inequation (4), y=K1c.

CS₃₀₋₆₀ integrated value: integrated value (Pa·m) of compressive stress CS at depth of 30 μm to 60 μm from surface

ICT: integrated value (Pa·m) of tensile stress

K1c: fracture toughness value (MPa·m^{1/2})

### Advantageous Effects of Invention

According to the manufacturing method of the present invention, the amount of ion diffusion can be increased by the first ion exchange treatment that imparts a tensile stress exceeding a CT limit value to the glass for chemical strengthening, and the subsequent second ion exchange treatment of reducing the tensile stress to less than the CT limit value. As a result, while avoiding the CT limit, a surface layer compressive stress of the glass that contributes to the set drop strength can be increased, and a chemically strengthened glass with a high set drop strength that was difficult to achieve by the manufacturing methods in the related art can be manufactured.

### BRIEF DESCRIPTION OF DRAWINGS

FIGS. 1A to 1C show schematic diagrams for explaining ion exchange in one embodiment of the present invention. FIG. 1A shows a first ion exchange treatment, and FIGS. 1B and 1C show a second ion exchange treatment.

FIGS. 2A and 2B each shows one aspect of a stress profile of a chemically strengthened glass obtained by a manufacturing method of one embodiment of the present invention. FIG. 2A shows a stress profile after the first ion exchange treatment, and FIG. 2B shows a stress profile after the second ion exchange treatment.

FIGS. 3A and 3B are diagrams showing correlations between CS₅₀/CTave and CS₃₀₋₆₀ integrated value/ICT in a glass of one embodiment of the present invention.

FIG. 4 is a diagram showing a correlation between CS₃₀₋₆₀ integrated value/ICT and K1c³.

### DESCRIPTION OF EMBODIMENTS

In the present description, the “fracture toughness value” is a value obtained by the IF method defined in JIS R1607:2015.

<Stress Measurement Method>

In recent years, glass that has undergone two-stage chemical strengthening by exchanging lithium ions inside the glass with sodium ions (Li—Na exchange), and then exchanging the sodium ions inside the glass with potassium ions (Na—K exchange) on a surface layer portion of the glass has become mainstream for cover glass of a smartphone and the like.

In order to obtain a stress profile of such two-stage chemically strengthened glass in a non-destructive manner, for example, a scattered light photoelastic stress meter (hereinafter, also abbreviated as SLP), a film stress measurement (hereinafter, also abbreviated as FSM), or the like may be used in combination.

In the method using the scattered light photoelastic stress meter (SLP), a compressive stress derived from the Li—Na exchange can be measured inside the glass at a distance of several tens of μm or more from a glass surface layer. On the other hand, in the method of using the film stress measurement (FSM), the compressive stress derived from Na—K exchange can be measured in the glass surface layer portion, which is separated from the glass surface by several tens of μm or less (for example, WO2018/056121 and WO2017/115811). Therefore, as the stress profile in the glass surface layer and inside of the two-stage chemically strengthened glass, a combination of SLP information and FSM information is sometimes used.

In the present invention, the stress profile measured mainly by the scattered light photoelastic stress meter (SLP) is used. In the present description, a compressive stress CS, a tensile stress CT, a compressive stress layer depth DOL, or the like means a value in a SLP stress profile.

The scattered light photoelastic stress meter is a stress measuring device including: a polarization phase difference variable member that changes a polarization phase difference of laser light by one wavelength or more with respect to a wavelength of the laser light; an imaging element that acquires a plurality of images by imaging, a plurality of times at predetermined time intervals, scattered light emitted when the laser beam having the variable polarization phase difference is incident on the strengthened glass; and a calculation unit that measures a periodic luminance change of the scattered light using the plurality of images, calculates a phase change of the luminance change, and calculates stress distribution in a depth direction from a surface of the strengthened glass based on the phase change.

A method for measuring the stress profile using the scattered light photoelastic stress meter includes a method described in WO2018/056121. Examples of the scattered light photoelastic stress meter include SLP-1000 and SLP-2000 manufactured by Orihara industrial Co., Ltd. Combining attached software SlpIV_up3 (Ver.2019.01.10.001) with these scattered light photoelastic stress meters enables highly accurate stress measurement.

<Chemically Strengthened Glass Manufacturing Method>

The chemical strengthening treatment is a treatment in which, by a method of immersing the glass into a melt of a metal salt (for example, sodium nitrate or potassium nitrate) containing metal ions (typically, sodium ions or potassium ions) having a large ionic radius, applying or straying the melt of the metal salt containing metal ions onto the glass, the glass is brought into contact with the metal salt, and thus metal ions having a small ion radius (typically, lithium ions or sodium ions) in the glass are substituted with the metal ions having a large ion radius (typically, sodium ions or potassium ions for lithium ions, and potassium ions for sodium ions).

When a glass article is dropped onto an asphalt-paved road or grit, a crack may develop due to collision with a protrusion such as a grit object. Although a length of the crack depends on a size of the grit object with which the glass article collides, the glass article can be prevented from breaking into fragments even when colliding with a relatively large protrusion in the case where a value of a compressive stress CS₅₀ (MPa) at a depth of 50 μm from a glass surface is set large, in which a stress profile having a large compressive stress around the depth of 50 μm, for example, is formed. Therefore, CS₅₀ is a parameter that greatly contributes to improvement of resistance to fracture, that is, a set drop strength, due to drop impact, and in order to increase the set drop strength, it is necessary to increase CS₅₀.

The compressive stress CS % at a depth of 90 μm is also a parameter that contributes to improvement of the set drop strength. The glass article can be prevented from breaking into fragments even when colliding with a relatively large protrusion in the case where a value of the compressive stress CS₉₀ (MPa) at a depth of 90 μm from the glass surface, which is measured by the scattered light photoelastic stress meter, is set large, in which a stress profile having a large compressive stress around the depth of 90 μm, for example, is formed.

The chemically strengthened glass manufacturing method of the present invention (hereinafter also referred to as the present manufacturing method) is characterized by sequentially including the following first ion exchange treatment and second ion exchange treatment.

(First ion exchange treatment) The first ion exchange treatment is an ion exchange treatment of bringing a first molten salt composition into contact with a glass for chemical strengthening having a CTA value of x (unit: MPa) so that a CTave value (MPa) of the glass for chemical strengthening exceeds x (MPa).

(Second ion exchange treatment) The second ion exchange treatment is an ion exchange treatment, after the first ion exchange treatment, of bringing the glass for chemical strengthening into contact with a second molten salt composition having a component ratio different from a component ratio of the first molten salt composition so that the CTave value of the glass for chemical strengthening is less than x (unit: MPa).

CTA is obtained by Equation (1) shown below. CTA corresponds to a CT limit and is a value determined by a composition of the glass for chemical strengthening.

[Eq. 2]

CTA=317.93×K1c/\sqrt{t}+228.5×t−398 Equation (1)

t: plate thickness (μm)

K1c: fracture toughness value (MPa·m^{1/2})

CTave is obtained by the Equation (2) shown below. CTave is a value corresponding to an average value of tensile stress.

CTave=ICT/L_{cT} Equation (2)

ICT: integrated value (Pa·m) of tensile stress

L_{CT}: plate thickness direction length (μm) of tensile stress area

In one embodiment of the present manufacturing method, it is preferable that in the first ion exchange treatment, the glass for chemical strengthening includes a first alkali metal ion, and the first molten salt composition includes second alkali metal ion having a larger ion radius than the first alkali metal ion. It is preferable that in the second ion exchange treatment, the second molten salt composition includes a third alkali metal ion having a larger ion radius than the second alkali metal ion. More preferably, the second molten salt composition further includes the first alkali metal ion.

In the present embodiment, the first ion exchange treatment exchanges the first alkali metal ions in the glass for chemical strengthening with the second alkali metal ions in the first molten salt composition. The second ion exchange treatment exchanges the second alkali metal ions in the glass for chemical strengthening with the third alkali metal ions in the second molten salt composition.

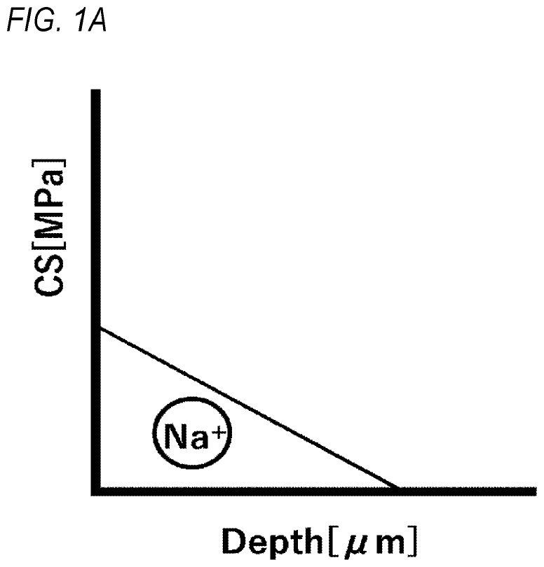

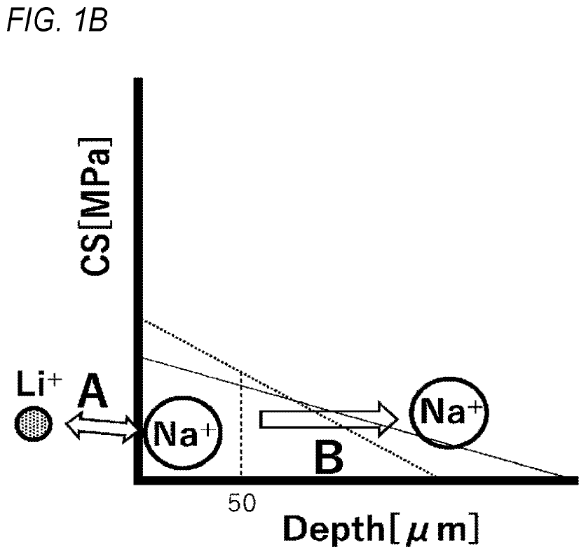

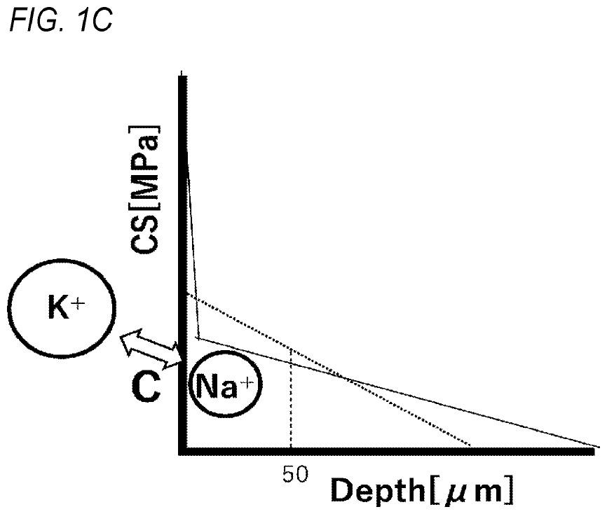

FIGS. 1A to 1C show schematic diagrams for explaining ion exchange in the present embodiment. In the present embodiment, the first alkali metal ions are lithium (Li) ions, and the second alkali metal ions are sodium (Na) ions, and the third alkali metal ions are potassium (K) ions.

FIG. 1A shows the first ion exchange treatment, and FIGS. 1B and 1C show the second ion exchange treatment. In the first ion exchange treatment, as shown in FIG. 1A, by the ion exchange between the first alkali metal ions in the glass for chemical strengthening and the second alkali metal ions in the first molten salt composition, the second alkali metal ions are introduced into the glass until a tensile stress exceeds a CT limit value (represented by a CTA value in the present invention).

As shown in FIGS. 1B and 1C, the second ion exchange treatment causes ion movements indicated by A to C below.

A. The second alkali metal ions escape from the glass in an area having a depth of 0 μm to 50 μm from a glass surface. This can reduce excess second alkali metal ions in the glass and control the tensile stress to less than the CT limit value.

B. In the area having the depth of 0 μm to 50 μm from the glass surface, the second alkali metal ions are diffused into a glass surface layer (an area having a depth of greater than 50 μm from the glass surface). This can create a surface layer compressive stress that contributes to the set drop strength.

C. The third alkali metal ions are introduced into the glass surface layer by the ion exchanging between the third alkali metal ions in the second molten salt composition and the second alkali metal ions in the glass for chemical strengthening. This can improve the surface layer compressive stress of the glass.

The movements of the ions may reduce excess second alkali metal ions in the glass to avoid the CT limit, and may maintain a high CS in the area having the depth of greater than 50 μm from the surface to create a stress profile with a high surface layer compressive stress.

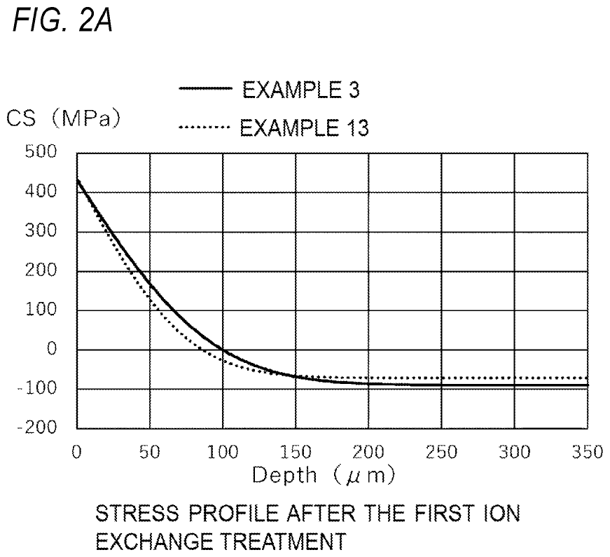

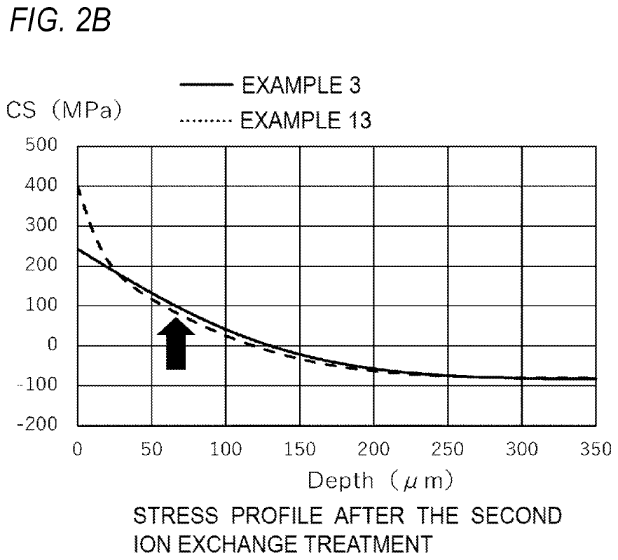

FIGS. 2A and 2B each show one aspect of a stress profile of a chemically strengthened glass obtained by the manufacturing method of the present embodiment. FIG. 2A shows a stress profile after the first ion exchange treatment, and FIG. 2B shows a stress profile after the second ion exchange treatment. In FIGS. 2A and 2B, a solid line indicates an example, and a dotted line indicates a comparative example.

As shown in FIG. 2A, the stress profile of the chemically strengthened glass obtained by the manufacturing method of the present embodiment, as compared with a chemically strengthened glass showing the same compressive stress layer depth obtained by a two-stage strengthening in the related art, can be formed with a lower CS₀ and a higher surface layer compressive stress by keeping CS high in the area having the depth of greater than 50 μm from the surface. In this way, the chemically strengthened glass obtained by the manufacturing method of the present embodiment exhibits an excellent set drop strength while avoiding the CT limit.

The first and second ion exchange treatments are described in detail below.

<<First Ion Exchange Treatment>>

The first ion exchange treatment is an ion exchange treatment of bringing the first molten salt composition into contact with the glass for chemical strengthening having a CTA value of x (unit: MPa) so that a CTave value (MPa) of the glass for chemical strengthening exceeds x (unit: MPa). The CTave value can be controlled by ion exchange treatment conditions (composition and temperature of the molten salt composition, and a contact time between the molten salt composition and the glass for chemical strengthening).

In the first ion exchange treatment, a difference between the CTave value and the CTA value x is not particularly limited as long as the CTave value exceeds the CTA value x, and from the viewpoint of improving the set drop strength, usually a value obtained by subtracting the CTA value x from the CTave value is preferably 2 MPa or more, more preferably 4 MPa or more, further preferably 6 MPa or more, and particularly preferably 8 MPa or more. From the viewpoint of manufacturing efficiency, the value obtained by subtracting the CTA value x from the CTave value is preferably 6 MPa or less, more preferably 4 MPa or less, further preferably 2 MPa or less, and particularly preferably 1 MPa or less. The difference between the CTave value and the CTA value can be appropriately adjusted depending on the glass composition of the glass for chemical strengthening, the conditions of the ion exchange treatment, and the like.

In one embodiment, in the first ion exchange treatment, it is preferable to bring the glass for chemical strengthening including the first alkali metal ions into contact with the first molten salt composition including the second alkali metal ions having a larger ion radius than the first alkali metal ions to exchange ions. In the present embodiment, the first ion exchange treatment introduces the second alkali metal ions into the glass for chemical strengthening until the CTave value exceeds the CTA value x. As a result, when the CTave value is lowered to less than the CTA value in the subsequent second ion exchange treatment, the amount of diffusion of the second alkali ions into an inside of the glass is increased, and therefore CS at a depth that contributes to the set drop strength can be increased, and the set drop strength can be improved.

In the present description, the term “molten salt composition” refers to a composition including a molten salt. Examples of the molten salt included in the molten salt composition include nitrates, sulfates, carbonates and chlorides. Examples of nitrate include lithium nitrate, sodium nitrate, potassium nitrate, cesium nitrate, rubidium nitrate, and silver nitrate. Examples of sulfate include lithium sulfate, sodium sulfate, potassium sulfate, cesium sulfate, rubidium sulfate, and silver sulfate. Examples of chloride include lithium chloride, sodium chloride, potassium chloride, cesium chloride, rubidium chloride, and silver chloride. These molten salts may be used alone, or may be used in combination.

The molten salt composition is preferably composition including nitrate as a base component, more preferably composition sodium nitrate or potassium nitrate as a base component. In the present description, the term “as a base component” means that a content in the molten salt composition is 80 mass % or more.

The composition of the first molten salt composition used in the first ion exchange treatment is not particularly limited as long as it does not impair the effects of the present invention, and as one embodiment, it is preferable to include the second alkali metal ions having a larger ion radius than the first alkali metal ions included in the glass for chemical strengthening. In the case where the first alkali metal ions are lithium ions, sodium ions are preferred as the second alkali metal ions. Examples of a molten salt including sodium ions include sodium nitrate, sodium sulfate, and sodium chloride, and among these, sodium nitrate is preferred.

In the case where the first molten salt composition includes sodium nitrate, a content thereof is preferably 20 mass % or more, more preferably 30 mass % or more, and further preferably 50 mass % or more. The content thereof is preferably 99 mass % or less, more preferably 95 mass % or less, and further preferably 90 mass % or less.

In the first ion exchange treatment, the glass for chemical strengthening is preferably brought into contact with the first molten salt composition at 360° C. or higher. In the case where the temperature of the first molten salt composition is 360° C. or higher, ion exchange is easy to proceed, and the compressive stress is easy to be introduced to a range exceeding the CT limit. The temperature of the first molten salt composition is more preferably 380° C. or higher, further preferably 421° C. or higher, and particularly preferably 430° C. or higher. The temperature of the first molten salt composition is usually 450° C. or lower from the viewpoints of danger due to evaporation and changes in composition of the molten salt composition.

In the first ion exchange treatment, the contact time of the glass for chemical strengthening with the first molten salt composition is preferably 0.5 hours or longer because the surface compressive stress increases. The contact time is more preferably 1 hour or longer. In the case where the contact time is too long, not only does productivity decrease, but the compressive stress may decrease due to a relaxation phenomenon. Therefore, the contact time is usually 8 hours or less.

The first ion exchange treatment may be a one-stage treatment, or a treatment (multi-stage strengthening) having two or more stages under two or more different conditions. In the case where the first ion exchange treatment is multi-stage strengthening, the CTave value of the glass for chemical strengthening after the multi-stage strengthening may exceed the CTA value x.

<<Second Ion Exchange Treatment>>

The second ion exchange treatment is an ion exchange treatment, after the first ion exchange treatment, of bringing the glass for chemical strengthening into contact with the second molten salt composition having a component ratio different from the component ratio of the first molten salt composition so that the CTave value of the glass for chemical strengthening is less than x (unit:MPa).

In the second ion exchange treatment, a difference between the CTave value and the CTA value x is not particularly limited as long as the CTave value is less than the CTA value x, and from the viewpoint of preventing the glass from self-destruct, usually a value obtained by subtracting the CTave value from the CTA value x is preferably 2 MPa or more, more preferably 4 MPa or more, and further preferably 6 MPa or more. From the viewpoint of ensuring the manufacturing efficiency and the set drop strength, usually, the difference is preferably 6 MPa or less, more preferably 4 MPa or less, and further preferably 2 MPa or less. The difference between the CTave value and the CTA value can be appropriately adjusted depending on the glass composition of the glass for chemical strengthening, the conditions of the ion exchange treatment, and the like.

In one embodiment, in the second ion exchange treatment, it is preferable to bring the glass for chemical strengthening, which the second alkali metal ions are excessively introduced into after the first ion exchange treatment, into contact with the second molten salt composition including the third alkali metal ions having a larger ion radius than the second alkali metal ions.

The composition of the second molten salt composition used in the second ion exchange treatment is not particularly limited as long as it does not impair the effects of the present invention, and as one embodiment, it is preferable to include the third alkali metal ions having a larger ion radius than the second alkali metal ions. In the case where the second alkali metal ions are sodium ions, potassium ions are preferred as the third alkali metal ions. Examples of the molten salt including potassium ions include potassium nitrate, potassium sulfate, and potassium chloride, and among these, potassium nitrate is preferred.

In the present embodiment, the second molten salt composition preferably further includes the first alkali metal ions in addition to the third alkali metal ions. By including the first alkali metal ions in the second molten salt composition, the exchange between the second alkali metal ions introduced near the glass surface by the first ion exchange treatment and the first alkali metal ions in the second molten salt composition can occur in equilibrium with the exchange between the second alkali metal ions and the third alkali metal ions in the second molten salt composition, and the surface compressive stress of the glass can be reduced.

In the present embodiment, a content ratio (mass ratio), first alkali metal ions/third alkali metal ions, of the first alkali metal ions to the third alkali metal ions in the second molten salt composition is preferably 100 to 30,000, more preferably 200 to 20,000, and further preferably 300 to 5,000.

In the present embodiment, in the case where the second molten salt composition includes potassium nitrate, a content thereof is preferably 85 mass % or more, more preferably mass % or more, and further preferably 95 mass % or more. The content thereof is preferably 99.9 mass % or less, more preferably 99.5 mass % or less, and further preferably 99 mass % or less.

In the present embodiment, in the case where the second molten salt composition includes lithium nitrate, a content thereof is preferably 0.01 mass % or more, more preferably mass % or more, and further preferably 0.3 mass % or more. The content thereof is preferably 2 mass % or less, more preferably 1 mass % or less, and further preferably 0.5 mass % or less.

In the present embodiment, the second molten salt composition may further include additives other than nitrates. Examples of the additive include silicic acid and specific inorganic salts. The second molten salt composition including additives can increase the surface compressive stress CS₀.

Silicic acid refers to a compound containing silicon, hydrogen, and oxygen represented by a chemical formula of nSiO₂·xH₂O. Here, n and x are natural numbers. Examples of such silicic acid include metasilicic acid (SiO₂·H₂O), metadisilicic acid (2SiO₂·H₂O), orthosilicic acid (SiO₂·2H₂O), pyrosilicic acid (2SiO₂·3H₂O), and silica gel [SiO₂·mH₂O (m is a real number of 0.1 to 1)].

In the present embodiment, in the case where silicic acid is added to the second molten salt composition, a content thereof is preferably 0.1 mass % or more, more preferably mass % or more, and most preferably 0.5 mass % or more. The content of silicic acid is preferably 3 mass % or less, more preferably 2 mass % or less, and most preferably 1 mass % or less.

The silicic acid is preferably silica gel [SiO₂·mH₂O (m is a real number of 0.1 to 1)]. Since silica gel has relatively large secondary particles, it tends to settle in the molten salt and has an advantage of being easy to charge and recover. There is also no worry about scattering dust, so that safety of workers can be ensured. Furthermore, since the silica gel is a porous body and the molten salt is easily supplied to a surface of the primary particles thereof, it is excellent in reactivity.

In the present embodiment, the second molten salt composition may include a specific inorganic salt (hereinafter referred to as flux) as an additive. Carbonates, hydrogencarbonates, phosphates, sulfates, hydroxides, and chlorides are preferred as the flux, and at least one salt selected from the group consisting of K₂CO₃, Na₂CO₃, KHCO₃, NaHCO₃, K₃PO₄, Na₃PO₄, K₂SO₄, Na₂SO₄, KOH, NaOH, KCl, and NaCl is preferably included. At least one salt selected from the group consisting of K₂CO₃ and Na₂CO₃ is more preferably included. K₂CO₃ is further preferred.

In the present embodiment, in the second ion exchange treatment, the glass for chemical strengthening is preferably brought into contact with the second molten salt composition at 360° C. or higher. In the case where the temperature of the second molten salt composition is 360° C. or higher, ion exchange is easy to proceed, and the compressive stress is easy to be introduced. The temperature of the first molten salt composition is more preferably 380° C. or higher, further preferably 421° C. or higher, and particularly preferably 430° C. or higher. The temperature of the second molten salt composition is usually 450° C. or lower from the viewpoints of danger due to evaporation and changes in composition of the molten salt composition.

In the present embodiment, a time t2 (minutes) for immersing the glass for chemical strengthening in the second molten salt composition with respect to the temperature T (° C.) of the second molten salt composition preferably satisfies the following inequation. In this way, the surface compressive stress of the glass can be moderately reduced.

−0.35T+173<t2<−1.4T+650

t2 (minutes) is preferably greater than (−0.38T+173), more preferably (−0.36T+167) or more, and further preferably (−0.35T+167) or more. t2 (minutes) is preferably less than (−1.4T+650), more preferably (−1.3T+600) or less, and further preferably (−1.2T+550) or less.

The second ion exchange treatment may be a one-stage treatment, or a treatment (multi-stage strengthening) having two or more stages under two or more different conditions. In the case where the second ion exchange treatment is multi-stage strengthening, the CTave value of the glass for chemical strengthening after the multi-stage strengthening may be less than the CTA value x.

<<Base Compositions of Glass for Chemical Strengthening and Chemically Strengthened Glass>>

In the present description, a glass composition is expressed in terms of mol % based on oxides unless otherwise specified, and mol % is simply expressed as “%”. In the present description, “substantially not included” in the glass composition means that a component has a content of less than an impurity level included in raw materials and the like, that is, the component is not intentionally included. Specifically, the content is less than 0.1%, for example.

The glass for chemical strengthening in the present invention is preferably lithium-containing glass, and more preferably lithium aluminosilicate glass. The composition of the glass for chemical strengthening and the base composition of the chemically strengthened glass obtained by chemically strengthening the glass for chemical strengthening match each other. The composition of the glass for chemical strengthening is not particularly limited, and specific examples thereof include a glass composition X_{A} and a glass composition X_{B} described below.

In one embodiment, more specifically, the glass for chemical strengthening preferably has a glass composition (hereinafter referred to as glass composition X_{A}) including, as represented by mol % based on oxides, 52% to 75% of SiO₂, 8% to 20% of Al₂O₃, and 5% to 16% of Li₂O.

In another embodiment, more specifically, the glass for chemical strengthening preferably has a glass composition (hereinafter referred to as glass composition X_{B}) including, as represented by mol % based on oxides, 40% to 75% of SiO₂, 1% to 20% of Al₂O₃, and 5% to 35% of Li₂O.

Preferred glass compositions are described below.

In the glass for chemical strengthening in the present embodiment, SiO₂ is a component that forms a network structure of glass. It is also a component that increases chemical durability.

In the glass composition X_{A}, the content of SiO₂ is preferably 52% or more. The content of SiO₂ is more preferably 56% or more, further preferably 60% or more, particularly preferably 64% or more, and extremely preferably 68% or more. On the other hand, in the glass composition X_{A}, the content of SiO₂ is preferably 75% or less, more preferably 73% or less, further preferably 71% or less, and particularly preferably 69% or less in order to improve meltability.

In the glass composition X_{B}, the content of SiO₂ is preferably 40% or more. The content of SiO₂ is more preferably 45% or more, further preferably 50% or more, particularly preferably 52% or more, and extremely preferably 54% or more. On the other hand, in the glass composition X_{B}, the content of SiO₂ is preferably 75% or less, more preferably 70% or less, further preferably 68% or less, still further preferably 66% or less, and particularly preferably 64% or less, in order to improve meltability.

Al₂O₃ is a component that increases the surface compressive stress by chemical strengthening and is essential.

In the glass composition X_{A}, the content of Al₂O₃ is preferably 8% or more, more preferably 10% or more, 11% or more, 12% or more, 13% or more in this order, further preferably 14% or more, and particularly preferably 15% or more. On the other hand, in the glass composition X_{A}, the content of Al₂O₃ is preferably 20% or less, more preferably 18% or less, further preferably 17% or less and 16% or less in this order, and most preferably 15% or less in order to prevent a devitrification temperature of the glass from becoming too high.

In the glass composition X_{B}, the content of Al₂O₃ is preferably 1% or more, more preferably 2% or more, further preferably 3% or more, 5% or more, 5.5% or more, and 6% or more in this order, particularly preferably 6.5% or more, and most preferably 7% or more. On the other hand, in the glass composition X_{B}, the content of Al₂O₃ is preferably 20% or less, more preferably 15% or less, further preferably 12% or less, and 10% or less in this order, particularly preferably 9% or less, and most preferably 8% or less in order to prevent the devitrification temperature of the glass from becoming too high.

Li₂O is a component that forms the compressive stress by ion exchange, and is essential since it is a constituent component of main crystal.

In the glass composition X_{A}, the content of Li₂O is preferably 5% or more, more preferably 7% or more, further preferably 10% or more, 14% or more, 15% or more, and 18% or more in this order, particularly preferably 20% or more, and most preferably 22% or more. On the other hand, in the glass composition X_{A}, the content of Li₂O is preferably 16% or less, more preferably 15% or less, further preferably 14% or less, and most preferably 12% or less in order to stabilize the glass.

In the glass composition X_{B}, the content of Li₂O is preferably 5% or more, more preferably 7% or more, further preferably 10% or more, 14% or more, 15% or more, and 18% or more in this order, particularly preferably 20% or more, and most preferably 22% or more. On the other hand, in the glass composition X_{B}, the content of Li₂O is preferably 35% or less, more preferably 32% or less, further preferably 30% or less, particularly preferably 28% or less, and most preferably 26% or less in order to stabilize the glass.

Na₂O is a component that improves meltability of the glass.

In the glass composition X_{A}, Na₂O is not essential, but in the case where it is included, a content thereof is preferably 1% or more, more preferably 2% or more, and particularly preferably 5% or more. In the case where the amount of Na₂O is too large, crystals are less likely to precipitate or chemical strengthening characteristics deteriorate, and therefore, in the glass composition X_{A}, the content of Na₂O is preferably 15% or less, more preferably 12% or less, and particularly preferably 10% or less.

In the glass composition X_{B}, Na₂O is not essential, but in the case where it is included, the content thereof is preferably 0.5% or more, more preferably 1% or more, and particularly preferably 2% or more. In the case where the amount of Na₂O is too large, crystals are less likely to precipitate or chemical strengthening characteristics deteriorate, and therefore, in the glass composition X_{B}, the content of Na₂O is preferably 5% or less, more preferably 3% or less, further preferably 2.5% or less, particularly preferably 2% or less, and most preferably 1.5% or less.

Similar to Na₂O, K2O is also a component that lowers the melting temperature of the glass and may be included.

In the case where K2O is included, a content thereof is preferably 0.5% or more, more preferably 0.8% or more, and further preferably 1% or more.

In the glass composition X_{A}, in the case where the amount of K2O is too large, the chemical strengthening characteristics or the chemical durability decrease, and therefore, the content thereof is preferably 1% or less, more preferably 0.8% or less, further preferably 0.6% or less, particularly preferably 0.5% or less, and most preferably 0.4% or less. In the glass composition X_{B}, in the case where the amount of K2O is too large, the chemical strengthening characteristics or the chemical durability decrease, and therefore, the content thereof is preferably 5% or less, more preferably 4% or less, further preferably 3.5% or less, particularly preferably 3% or less.

In the glass composition X_{A}, a total content of Na₂O and K2O, that is Na₂O+K₂O, is preferably 3% or more, and more preferably 5% or more, in order to improve the meltability of the glass raw materials. In the glass composition X_{A}, a ratio, that is K₂O/R₂O, of the content of K₂O to a total content of Li₂O, Na₂O and K₂O (hereinafter referred to as R₂O) is preferably 0.2 or less because the chemical strengthening characteristics can be enhanced and the chemical durability can be improved. In the glass composition X_{A}, K₂O/R₂O is more preferably 0.15 or less, and further preferably 0.10 or less. In the glass composition X_{A}, R₂O is preferably 10% or more, more preferably 12% or more, and further preferably 15% or more. In the glass composition X_{A}, R₂O is preferably 20% or less, and more preferably 18% or less.

In the glass composition X_{B}, the total content of Na₂O and K2O, that is Na₂O+K2O, is preferably 1% or more, and more preferably 2% or more, in order to improve the meltability of the glass raw materials. In the glass composition X_{B}, the ratio, that is K₂O/R₂O, of the content of K₂O to the total content of Li₂O, Na₂O and K₂O (hereinafter referred to as R₂O) is preferably 0.2 or less because the chemical strengthening characteristics can be enhanced and the chemical durability can be improved. In the glass composition X_{B}, K₂O/R₂O is more preferably 0.15 or less, and further preferably 0.10 or less. In the glass composition X_{B}, R₂O is preferably 10% or more, more preferably 15% or more, and further preferably 20% or more. In the glass composition X_{B}, R₂O is preferably 29% or less, and more preferably 26% or less.

P₂O₅ is a component that enlarges the compressive stress layer by chemical strengthening and may be included. P₂O₅ is a constituent component of Li₃PO₄ crystal and is essential in glass with Li₃PO₄ crystal. In order to promote crystallization, a content of P₂O₅ is preferably 0.5% or more, more preferably 1% or more, further preferably 1.5% or more, particularly preferably 2% or more, and extremely preferably 2.5% or more.

On the other hand, in the case where the content of P₂O₅ is too high, phase separation tends to occur during melting and acid resistance is remarkably lowered, and therefore, the content of P₂O₅ is preferably 5% or less, more preferably 4.8% or less, further preferably 4.5% or less, and particularly preferably 4.2% or less.

ZrO₂ is a component that increases mechanical strength and chemical durability, and is preferably included in order to remarkably improve CS. A content of ZrO₂ is preferably or more, more preferably 1% or more, further preferably 1.5% or more, particularly preferably 2% or more, and most preferably 2.5% or more.

On the other hand, in order to prevent devitrification during melting, the content of ZrO₂ is preferably 8% or less, more preferably 7.5% or less, further preferably 7% or less, and particularly preferably 6% or less. In the case where the content of ZrO₂ is too high, the devitrification temperature rises and then the viscosity decreases. In order to prevent deterioration of moldability due to such a decrease in viscosity, in the case where a molding viscosity is low, the content of ZrO₂ is preferably 5% or less, more preferably 4.5% or less, and further preferably 3.5% or less.

In the glass composition X_{A}, ZrO₂/R₂O is preferably 0.02 or more, more preferably or more, further preferably 0.06 or more, particularly preferably 0.08 or more, and most preferably 0.1 or more, in order to increase the chemical durability. In the glass composition X_{A}, in order to increase transparency after crystallization, ZrO₂/R₂O is preferably 0.2 or less, more preferably 0.18 or less, further preferably 0.16 or less, and particularly preferably 0.14 or less.

In the glass composition X_{B}, ZrO₂/R₂O is preferably 0.02 or more, more preferably or more, further preferably 0.04 or more, particularly preferably 0.1 or more, and most preferably 0.15 or more, in order to increase the chemical durability. In the glass composition X_{B}, ZrO₂/R₂O is preferably 0.6 or less, more preferably 0.5 or less, further preferably 0.4 or less, and particularly preferably 0.3 or less, in order to increase the transparency after crystallization.

MgO is a component that stabilizes the glass, and is also a component that enhances the mechanical strength and chemical resistance, and therefore, MgO is preferably included in the case where the content of Al₂O₃ is relatively low. The content of MgO is preferably 1% or more, more preferably 2% or more, further preferably 3% or more, and particularly preferably 4% or more.

On the other hand, in the case where too much MgO is added, the viscosity of the glass is lowered, and devitrification or phase separation tends to occur. In the glass composition X_{A}, the content of MgO is preferably 20% or less, more preferably 19% or less, further preferably 18% or less, and particularly preferably 17% or less.

In the glass composition X_{B}, the content of MgO is preferably 10% or less, more preferably 9% or less, further preferably 8% or less, and particularly preferably 7% or less.

TiO₂ is a component capable of promoting crystallization and may be included.

In the glass composition X_{A}, TiO₂ is not essential, but in the case where it is included, a content thereof is preferably 0.05% or more, and more preferably 0.1% or more. On the other hand, in the glass composition X_{A}, the content of TiO₂ is preferably 1% or less, more preferably 0.5% or less, and further preferably 0.3% or less, in order to prevent the devitrification during melting.

In the glass composition X_{B}, TiO₂ is not essential, but in the case where it is included, the content thereof is preferably 0.2% or more, and more preferably 0.5% or more. On the other hand, in the glass composition X_{B}, the content of TiO₂ is preferably 4% or less, more preferably 2% or less, and further preferably 1% or less, in order to prevent the devitrification during melting.

SnO₂ has an effect of promoting formation of crystal nucleus and may be included.

In the glass composition X_{A}, SnO₂ is not essential, but in the case where it is included, a content thereof is preferably 0.5% or more, more preferably 1% or more, further preferably 1.5% or more, and particularly preferably 2% or more. On the other hand, in the glass composition X_{A}, in order to prevent the devitrification during melting, the content of SnO₂ is preferably 4% or less, more preferably 3.5% or less, further preferably 3% or less, and particularly preferably 2.5% or less.

In the glass composition X_{B}, SnO₂ is not essential, but in the case where it is included, a content thereof is preferably 0.005% or more, more preferably 0.01% or more, further preferably 0.02% or more, and particularly preferably 0.03% or more. On the other hand, in the glass composition X_{B}, in order to prevent the devitrification during melting, the content of SnO₂ is preferably 2% or less, more preferably 1% or less, further preferably 0.5% or less, and particularly preferably 0.1% or less.

Y₂O₃ is a component that has an effect of making it difficult for fragments to scatter in the case where the chemically strengthened glass is broken, and may be included. A content of Y₂O₃ is preferably 1% or more, more preferably 1.5% or more, further preferably 2% or more, particularly preferably 2.5% or more, and extremely preferably 3% or more. On the other hand, in order to prevent the devitrification during melting, the content of Y₂O₃ is preferably 5% or less, and more preferably 4% or less.

B₂O₃ is a component that improves chipping resistance of the glass for chemical strengthening or the chemically strengthened glass and improves the meltability, and may be included. In the case where B₂O₃ is included, a content thereof is preferably 0.5% or more, more preferably 1% or more, and further preferably 2% or more, in order to improve the meltability. On the other hand, in the case where the content of B₂O₃ is too large, striae may occur during melting, or phase separation tends to occur, and then the quality of the glass for chemical strengthening tends to deteriorate, so that the content thereof is preferably 10% or less. The content of B₂O₃ is more preferably 8% or less, further preferably 6% or less, and particularly preferably 4% or less.

All of BaO, SrO, MgO, CaO and ZnO are components that improve the meltability of the glass and may be included.

In the glass composition X_{B}, in the case where these components are included, a total content of BaO, SrO, MgO, CaO and ZnO (hereinafter, BaO+SrO+MgO+CaO+ZnO) is preferably 0.5% or more, more preferably 1% or more, further preferably 1.5% or more, and particularly preferably 2% or more. On the other hand, in the glass composition X_{B}, BaO+SrO+MgO+CaO+ZnO is preferably 8% or less, more preferably 6% or less, further preferably 5% or less, and particularly preferably 4% or less, since an ion exchange rate may decrease.

Among these, BaO, SrO, and ZnO may be included in order to improve light transmittance of the crystallized glass by improving a refractive index of the residual glass and bringing it closer to a precipitated crystal phase, thereby lowering a haze value.

In the glass composition X_{B}, BaO+SrO+ZnO is preferably 0.3% or more, more preferably 0.5% or more, further preferably 0.7% or more, and particularly preferably 1% or more. On the other hand, in the glass composition X_{B}, BaO+SrO+ZnO is preferably 2.5% or less, more preferably 2% or less, further preferably 1.7% or less, and particularly preferably 1.5% or less, in order to improve the chemical strengthening characteristics.

All of La₂O₃, Nb₂O₅ and Ta₂O₅ are components that make it difficult for fragments to scatter in the case where the chemically strengthened glass is broken, and may be included in order to increase the refractive index. In the case where these components are included, a total content of La₂O₃, Nb₂O₅ and Ta₂O₅ (hereinafter referred to as La₂O₃+Nb₂O₅+Ta₂O₅) is preferably 0.5% or more, more preferably 1% or more, further preferably 1.5% or more, and particularly preferably 2% or more. La₂O₃+Nb₂O₅+Ta₂O₅ is preferably 4% or less, more preferably 3% or less, further preferably 2% or less, and particularly preferably 1% or less because the glass is less likely to devitrify during melting.

CeO₂ may be included. CeO₂ may prevent coloring caused by oxidizing the glass. In the case where CeO₂ is included, a content thereof is preferably 0.03% or more, more preferably 0.05% or more, and further preferably 0.07% or more. The content of CeO₂ is preferably 1.5% or less, and more preferably 1.0% or less, in order to increase the transparency.

In the case where the chemically strengthened glass is colored and used, coloring components may be added within a range that does not impede achievement of desired chemical strengthening characteristics. Examples of the coloring component include Co₃O₄, MnO₂, Fe₂O₃, NiO, CuO, Cr₂O₃, V₂O₅, Bi₂O₃, SeO₂, Er₂O₃ and Nd₂O₃.

A total content of the coloring components is preferably in a range of 1% or less. In the case where it is desired to increase visible light transmittance of the glass, it is preferred that these components are not substantially included.

HfO₂, Nb₂O₅, and Ti₂O₃ may be added in order to increase weather resistance against irradiation with ultraviolet light. When added for the purpose of increasing weather resistance against ultraviolet light irradiation, a total content of HfO₂, Nb₂O₅, and Ti₂O₃ is preferably 1% or less, more preferably 0.5% or less, and further preferably 0.1% or less in order to reduce effects on other characteristics.

SO₃, chlorides, and fluorides may be appropriately included as refining agents during melting of the glass. A total content of components that function as the refining agent is, as represented by mass % based on oxides, preferably 2% or less, more preferably 1% or less, and further preferably 0.5% or less, since in the case where too much refining agent is added, the strengthening characteristics and crystallization behavior may be affected. Although a lower limit thereof is not particularly limited, it is typically preferably 0.05% or more in total as represented by mass % based on oxides.

In the case where SO₃ is used as the refining agent, a content of SO₃ is, as represented by mass % based on oxides, preferably 0.01% or more, more preferably 0.05% or more, and further preferably 0.1% or more, since in the case where the content is too small, the effect thereof cannot be achieved. In the case where SO₃ is used as the refining agent, the content of SO₃ is, as represented by mass % based on oxides, preferably 1% or less, more preferably 0.8% or less, and further preferably 0.6% or less.

In the case where Cl is used as the refining agent, a content of Cl is, as represented by mass % based on oxides, preferably 1% or less, more preferably 0.8% or less, and further preferably 0.6% or less, since in the case where it is added too much, physical properties such as the strengthening characteristics may be affected. In the case where Cl is used as the refining agent, the content of Cl is, as represented by mass % based on oxides, preferably or more, more preferably 0.1% or more, and further preferably 0.2% or more, since in the case where the content is too small, the effect thereof cannot be achieved.

In the case where SnO₂ is used as the refining agent, a content of SnO₂ is, as represented by mass % based on oxides, preferably 1% or less, more preferably 0.5% or less, and further preferably 0.3% or less, since in the case where it is added too much, the crystallization behavior may be affected. In the case where SnO₂ is used as the refining agent, a content of SnO₂ is, as represented by mass % based on oxides, preferably 0.02% or more, more preferably 0.05% or more, and further preferably 0.1% or more, since in the case where the content is too small, the effect thereof cannot be achieved.

As₂O₃ is preferably not included. In the case where Sb₂O₃ is included, a content thereof is preferably 0.3% or less, more preferably 0.1% or less, and most preferably not included.

The glass for chemical strengthening of the present embodiment has, for example, the composition as described above. In order to obtain a glass having the above composition, the glass raw materials are appropriately mixed, and heated and melted in a glass melting furnace. Thereafter, the molten glass is homogenized by bubbling, stirring, addition of a refining agent, and the like, and formed into a glass sheet having a predetermined thickness, followed by annealed. Alternatively, the molten glass may be formed into a block shape, annealed, and then cut into a sheet shape.

Examples of methods for forming a sheet shape include a float method, a press method, a fusion method, and a down-draw method. The float method is particularly preferable when manufacturing a large glass sheet. Further, a continuous forming method other than the float method, for example, a fusion method and a down-draw method are also preferable.

The glass for chemical strengthening may be crystallized glass. In the case where the glass for chemical strengthening is crystallized glass, crystallized glass including at least one kind of crystal selected from the group consisting of a lithium silicate crystal, a lithium aluminosilicate crystal, and a lithium phosphate crystal is preferable. The lithium silicate crystal is preferably a lithium metasilicate crystal, a lithium disilicate crystal, or the like. The lithium phosphate crystal is preferably a lithium orthophosphate crystal or the like. The lithium aluminosilicate crystal is preferably a p-spodumene crystal, a petalite crystal, or the like.

To increase the mechanical strength, the crystallization ratio of crystallized glass is preferably 10% or more, more preferably 15% or more, further preferably 20% or more, and particularly preferably 25% or more. To increase the transparency, the crystallization ratio of crystallized glass is preferably 70% or less, more preferably 60% or less, and particularly preferably 50% or less. Crystallized glass being small in crystallization ratio is superior in being formed easily by bend forming with heating. A crystallization ratio can be calculated by the Rietveld method from X-ray diffraction intensity. The Rietveld method is described in “Crystal Analysis Handbook” edited by the Crystallographic Society of Japan, “Crystal Analysis Handbook” (Kyoritsu Shuppan, 1999, pp. 492-499).

To increase the transparency, an average particle diameter of precipitated crystals of crystallized glass is preferably 300 nm or less, more preferably 200 nm or less, further preferably 150 nm or less, and particularly preferably 100 nm or less. An average particle diameter of precipitated crystals can be determined from a transmission electron microscope (TEM) image. It can also be estimated from a scanning electron microscope (SEM) image.

<Chemically Strengthened Glass>

In the present description, the “base composition of the chemically strengthened glass” is the glass composition of the glass for chemical strengthening, and except for the case where extreme ion exchange treatment is performed, the glass composition of a deeper portion than the compressive stress layer depth (hereinafter also abbreviated as DOL-zero) of the chemically strengthened glass is substantially the same as the base composition of the chemically strengthened glass.

A chemically strengthened glass of the present embodiment is obtained by the manufacturing method of the present embodiment described above. The chemically strengthened glass of the present embodiment is characterized in that the Z value represented by Equation (3) shown below satisfies Inequation (4) shown below.

Z=(CS₃₀₋₆₀ integrated value/ICT) Equation(3)

Z>0.29×y³+0.00086×ln(y²)+0.0013×y−0.0213×t Inequation (4)

In Inequation (4), y=K1c.

CS₃₀₋₆₀ integrated value: integrated value (Pa·m) of compressive stress CS at depth of 30 μm to 60 μm from surface

ICT: integrated value (Pa·m) of tensile stressK1c: fracture toughness value (MPa·m^{1/2})

The “fracture toughness value K1 c” is a value obtained by the IF method defined in JIS R1607:2015. The value of K1c is a value dependent on the glass composition and can be adjusted by the glass composition.

In the case where the Z value satisfies Inequation (4), the surface layer compressive stress can be increased and then the set drop strength can be improved.

The Z value can be adjusted by the composition of the glass for chemical strengthening, the conditions of the first ion exchange treatment and the second ion exchange treatment (compositions of the molten salt compositions, temperature, contact time), and the like.

From the viewpoint of improving the strength, the plate thickness t (mm) of the chemically strengthened glass in the present invention is preferably 0.8 mm or less, more preferably 0.7 mm or less, further preferably 0.65 mm or less, and particularly preferably 0.6 mm or less. The smaller t is, the more the strength is improved by the present invention. t is typically 0.02 mm or greater.

Since the chemically strengthened glass using the present invention can improve the set drop strength, the strength can be maintained even when a plate thickness of the glass is reduced. Specifically, a chemically strengthened glass with a plate thickness of t2 (t2 is a numerical value of less than t1) using the technique of the present invention can obtain a strength equal to or greater than that of a glass with a plate thickness of t1, which is chemically strengthened by a technique in the related art.

A first embodiment and a second embodiment will be described below as specific examples of the chemically strengthened glass of the present embodiment.

### Chemically Strengthened Glass of First Embodiment

A base composition of a chemically strengthened glass of the first embodiment preferably includes, as represented by mol % based on oxides, 52% to 75% of SiO₂, 8% to 20% of Al₂O₃, and 5% to 16% of Li₂O.

More preferably, the base composition of the chemically strengthened glass of the first embodiment includes, as represented by mol % based on oxides, 52% to 75% of SiO₂, 8% to 20% of Al₂O₃, 5% to 16% of Li₂O, 0% to 20% of MgO, 0% to 20% of CaO, 0% to 20% of SrO, 0% to 20% of BaO, 0% to 10% of ZnO, 0% to 1% of TiO₂, and 0% to 8% ZrO₂.

(Case where Plate Thickness is 0.7 mm)

In the case where the chemically strengthened glass of the first embodiment has a plate thickness of 0.7 mm, CS₃₀₋₆₀ integrated value/ICT, which is a value obtained by dividing CS₃₀₋₆₀ integrated value (Pa·m) that is an integrated value of the compressive stress CS at the depth of 30 μm to 60 nm from the surface by the integrated value ICT (Pa·m) of the tensile stress, is preferably 0.145 or more, more preferably 0.17 or more, and further preferably 0.2 or more.

A high CS₃₀₋₆₀ integrated value/ICT indicates that the surface layer compressive stress of the glass is high. In the case where CS₃₀₋₆₀ integrated value/ICT is 0.145 or more when the plate thickness is 0.7 mm, the surface layer compressive stress can be increased and the set drop strength can be improved.

In the case where the chemically strengthened glass of the first embodiment has a plate thickness of 0.7 mm, ICT is preferably 24,000 Pa·m or more, more preferably 26,000 Pa·m or more, and further preferably 28,000 Pa·m or more.

In the case where the chemically strengthened glass of the first embodiment has a plate thickness of 0.7 mm, CS₅₀/K1c, which is a value obtained by dividing a compressive stress CS₅₀ (MPa) at a depth of 50 nm from the surface by the fracture toughness value K1c (MPa·m^{1/2}), is preferably 152 or more, more preferably 160 or more, and further preferably 170 or more, from the viewpoint of improving the set drop strength.

In the case where the chemically strengthened glass of the first embodiment has a plate thickness of 0.7 mm, CS₅₀/CS₀, which is a value obtained by dividing the compressive stress CS₅₀ (MPa) at the depth of 50 μm from the surface by the surface compressive stress CS₀ (MPa), is preferably 0.140 or more, more preferably 0.150 or more, and further preferably 0.160 or more, from the viewpoint of improving the set drop strength.

In the case where the chemically strengthened glass of the first embodiment has a plate thickness of 0.7 mm, CS₅₀/CTave, which is a value obtained by dividing the compressive stress CS₅₀ (MPa) at the depth of 50 μm from the surface by the CTave value (MPa), is preferably 2.0 or more, more preferably 2.2 or more, and further preferably 2.5 or more.

(Case where Plate Thickness is t mm)

In the case where the chemically strengthened glass of the first embodiment has a plate thickness oft mm, from the viewpoint of improving the set drop strength by increasing the surface layer compressive stress, CS₃₀₋₆₀ integrated value/ICT is preferably (−0.442×t+0.2) or more, more preferably (−0.442×t+0.3) or more, and further preferably (−0.442×t+0.4) or more.

In the case where the chemically strengthened glass of the first embodiment has a plate thickness oft mm, ICT is preferably (32235×t+1000) or more, more preferably (32235×t+3000) or more, and further preferably (32235×t+5000) or more.

In the case where the chemically strengthened glass of the first embodiment has a plate thickness oft mm, from the viewpoint of improving the set drop strength, CS₅₀/K1c is preferably (225×t−25) or more, more preferably (225×t−15) or more, and further preferably (225×t−5) or more.

In the case where the chemically strengthened glass of the first embodiment has a plate thickness oft mm, from the viewpoint of improving the set drop strength, CS₅₀/CS₀ is preferably (0.25×t−0.05) or more, more preferably (0.25×t+0.05) or more, and further preferably (0.25×t+0.15) or more.

In the case where the chemically strengthened glass of the first embodiment has a plate thickness oft mm, CS₅₀/CTave is preferably (4.3×t−1) or more, more preferably (4.3×t−0.9) or more, and further preferably (4.3×t−0.8) or more.

### Chemically Strengthened Glass of Second Embodiment

A base composition of a chemically strengthened glass of the second embodiment preferably includes, as represented by mol % based on oxides, 40% to 75% of SiO₂, 1% to 20% of Al₂O₃, and 5% to 35% of Li₂O.

More preferably, the base composition of the chemically strengthened glass of the second embodiment includes, as represented by mol % based on oxides, 50% to 70% of SiO₂, 10% to 30% of Li₂O, 1% to 15% of Al₂O₃, 0% to 5% P₂O₅, 0% to 8% of ZrO₂, 0% to 10% of MgO, 0% to 5% of Y₂O₃, 0% to 10% of B₂O₃, 0% to 5% of Na₂O, 0% to 5% of K₂O, and 0% to 2% of SnO₂.

(Case where Plate Thickness is 0.7 mm)

In the case where the chemically strengthened glass of the second embodiment has a plate thickness of 0.7 mm, CS₃₀₋₆₀ integrated value/IC T, which is a value obtained by dividing CS₃₀₋₆₀ integrated value (Pa·m) that is an integrated value of the compressive stress CS at the depth of 30 μm to 60 μm from the surface by the integrated value ICT (Pa·m) of the tensile stress, is preferably 0.205 or more, more preferably 0.220 or more, and further preferably 0.250 or more.

A high CS₃₀₋₆₀ integrated value/ICT indicates that the surface layer compressive stress of the glass is high. In the case where CS₃₀₋₆₀ integrated value/ICT is 0.205 or more in the case where the plate thickness is 0.7 mm, the surface layer compressive stress can be increased and the set drop strength can be improved.

In the case where the chemically strengthened glass of the second embodiment has a plate thickness of 0.7 mm, CS₅₀/K1c, which is a value obtained by dividing a compressive stress CS₅₀ (MPa) at a depth of 50 μm from the surface by the fracture toughness value K1c (MPa·m^{1/2}), is preferably 240 or more, more preferably 260 or more, and further preferably 280 or more, from the viewpoint of improving the set drop strength. From the viewpoint of avoiding the CT limit, CS₅₀/K1c is preferably 360 or less, more preferably 340 or less, and further preferably 320 or less.

In the case where the chemically strengthened glass of the second embodiment has a plate thickness of 0.7 mm, CS₅₀/CTave, which is a value obtained by dividing the compressive stress CS₅₀ (MPa) at the depth of 50 μm from the surface by the CTave value (MPa), is preferably 2.6 or more, more preferably 3.0 or more, and further preferably 3.4 or more.

Case where Plate Thickness is t mm)

In the case where the chemically strengthened glass of the second embodiment has a plate thickness oft mm, CS₃₀₋₆₀ integrated value/ICT/t is preferably (−0.6×t+0.70) or more, more preferably (−0.6×t+0.74) or more, and further preferably (−0.6×t+0.78) or more.

In the case where the plate thickness is t mm, CS₅₀/K1c is preferably (350×t−15) or more, more preferably (350×t+5) or more, and further preferably (350×t+25) or more.

In the case where the plate thickness is t mm, CS₅₀/CTave is preferably (5×t−0.85) or more, more preferably (5×t−0.45) or more, and further preferably (5×t) or more.

Stress characteristics in the chemically strengthened glass of the present embodiment can be adjusted by the base composition thereof and the conditions of the ion exchange treatments.

<<Usage>>

The chemically strengthened glass of the present embodiment is also useful as a cover glass used for electronic devices such as mobile devices such as mobile phones and smart phones. Furthermore, it is also useful as a cover glass of electronic devices such as televisions, personal computers, and touch panels that are not intended for portability, walls of elevators, and walls (full-surface displays) of architectures such as houses and buildings. It is also useful as building materials such as window glass, table tops, interiors of automobiles, airplanes, and the like, cover glasses thereof, housings having curved surfaces, and the like.

### EXAMPLES

Although the present invention will be described below using Examples, it is not limited to those Examples.

<Preparation of Amorphous Glass and Crystallized Glass>

Glass raw materials were prepared so as to have a composition shown in below as represented by a mole percentage based on oxides, and weighed out to give 400 g of glass. Then, the mixed raw materials were put in a platinum crucible, put into an electric furnace at 1500° C. to 1700° C., melted for about 3 hours, defoamed, and homogenized. Glass material A: SiO₂ of 66%, Al₂O₃ of 12%, Y₂O₃ of 1.5%, ZrO₂ of 0.5%, Li₂O of 11%, Na₂O of 5%, K2O of 3%, other components of 1%.

Glass material B: SiO₂ of 61.0%, Al₂O₃ of 5.0%, Li₂O of 21.0%, Na₂O of 2.0%, P₂O₅ of 2.0%, MgO of 5.0%, ZrO₂ of 3.0%, Y₂O₃ of 1.0%.

The obtained molten glass was poured into a metal mold, held at a temperature of approximately 50° C. higher than a glass transition point for 1 hour, and then cooled to the room temperature at a rate of 0.5° C./min to thereby obtain a glass block. The obtained molten glass was poured into a mold, held at a temperature around a glass transition point (714° C.) for about 1 hour, and then cooled to room temperature at a rate of 0.5° C./min to thereby obtain a glass block.

[Fracture Toughness Value K1c]

The fracture toughness value K1c was measured by the IF method according to JIS R1607:2015 using a part of the obtained block. As a result, K1c was 0.80 (MPa·m^{1/2}) for the glass material A and 0.88 (MPa·m^{1/2}) for the glass material B.

[CTA value]

CTA value was obtained from the following Equation (1).

[Eq. 3]

CTA=317.93×K1c/\sqrt{t}+228.5×t−398 Equation (1)

t: plate thickness (μm)

The obtained glass block was cut, ground, and finally mirror-polished on both sides to obtain a glass sheet having an area of 50 mm×50 mm and a plate thickness of 0.7 mm. For Examples 17 to 24, crystallized glass was obtained by holding the obtained glass plate at 750° C. for 1 hour and then holding it at 900° C. for 4 hours.

<Evaluation of Chemical Strengthening Treatment and Strengthened Glass>

The glass plate obtained above was immersed in the molten salt composition under conditions shown in Tables 1 and 2, subjected to the first ion exchange treatment and the second ion exchange treatment, so as to produce the chemically strengthened glass in Examples 1 to 24 below. Examples 1 to 10 and 17 to 20 are Working Examples, and Examples 11 to 16 and 21 to 24 are Comparative Examples. In all of Examples 1 to 10 and 17 to 20, CTave after the second ion exchange treatment was less than the CTA value.

The obtained chemically strengthened glass was evaluated by the following methods.

[Stress Measurement Using Scattered Light Photoelastic Stress Meter]

Stress of the chemically strengthened glass was measured by the method described in WO 2018/056121 using a scattered light photoelastic stress meter (SLP-2000 produced by Orihara Industrial Co., Ltd.). A stress profile was calculated using software [S1pV (Ver. 2019.11.07.001)]attached to the scattered light photoelastic stress meter (SLP-2000 produced by Orihara Industrial Co., Ltd.).

A function σ(x)=[a₁×erfc(a₂×x)+a₃×erfc(a₄×x)+a₅] was used for calculating a stress profile. Here, aᵢ (i=1 to 5) is a fitting parameter and erfc is a complementary error function. The complementary error function is defined by the following equation.

$$\\ \begin{matrix}\begin{matrix}erfc ( x ) = 1 - erf ( x ) \\ = \frac{2}{\sqrt{π}} {\int }_{x}^{∞} {e}^{- {t}^{2}} dt = {e}^{- {x}^{2}} erfc x ( x )\end{matrix} & [ Eq . 4 ]\end{matrix}$$

In the evaluation employed in the present description, the fitting parameter was optimized by minimizing a residual sum of squares of raw data obtained and the above function. Measurement processing conditions were one-shot, and regarding measurement region processing adjustment items, an edge method was designated for the surface, 6.0 μm was designated for an inner surface edge, automatic was designated for inner left and right edges, and automatic (center of the sample film thickness) for an inner deep edge, and a fitting curve was designated for extension of a phase curve to a middle of a sample thickness.

At the same time, distributions of the concentrations of alkali metal ions (sodium ions and potassium ions) in a direction of cross section were measured using an electron probe micro analysis, and it was confirmed that there were no discrepancies between the stress profile obtained above and a result of this measurement.

From the obtained stress profile, values of compressive stresses CS₀, CS₅₀, CS₉₀, CTmax, integrated value ICT of CT, CTave, compressive stress layer depths DOLzero and DOLtail were calculated by the method described above. Results are shown in Tables 1 to 3.

In Tables 1 to 3, each notation represents the following.

CS₀ (MPa): compressive stress in the glass surface

CS₅₀ (MPa): compressive stress at a depth of 50 μm from the glass surface

CS₉₀ (MPa): compressive stress at a depth of 90 μm from the glass surface

CS₃₀₋₆₀ integrated value: integrated value (Pa·m) of compressive stress CS at depth of 30 μm to 60 μm from surface

CTave (MPa): average value of the tensile stress

CTmax (MPa): maximum tensile stress

ICT: integrated value (Pa·m) of tensile stress

K1c: fracture toughness value (MPa·m^{1/2})

DOLzero: surface layer compressive stress layer depth (μm)

DOLtail: surface layer compressive stress layer depth (μm)

FIGS. 2A and 2B each shows a stress profile of a chemically strengthened glass obtained by the manufacturing method of Example 3 and Example 13. FIG. 2A shows a stress profile after the first ion exchange treatment, and FIG. 2B shows a stress profile after the second ion exchange treatment.

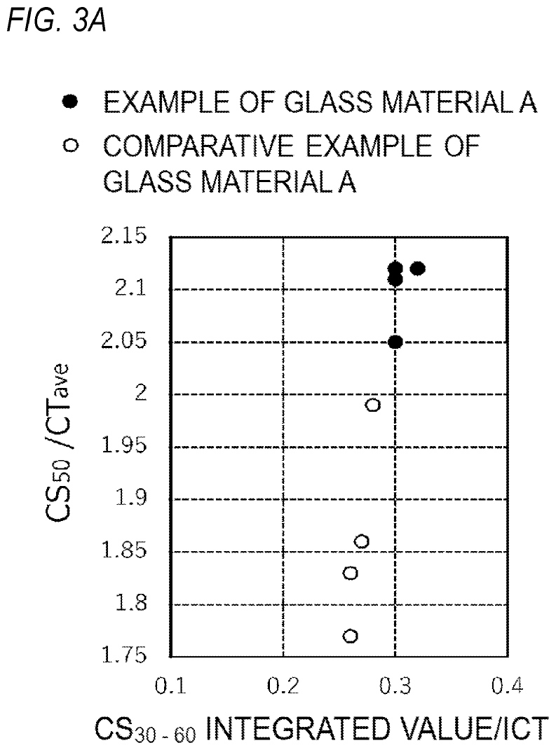

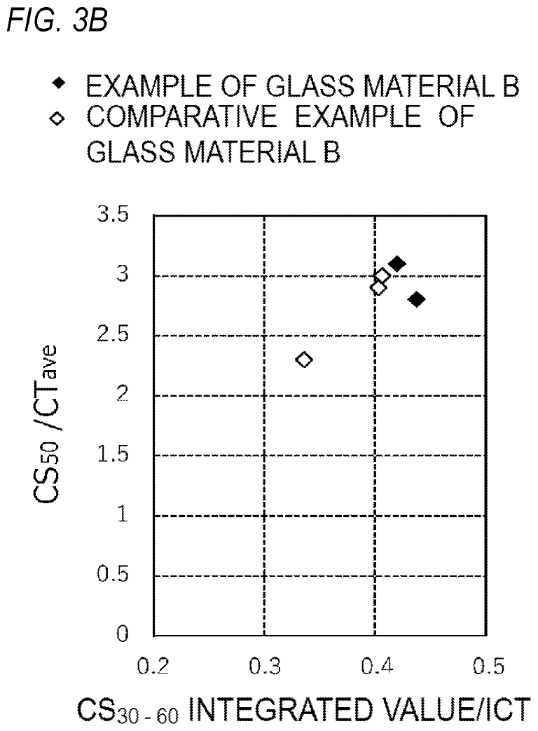

FIGS. 3A and 3B are diagrams showing correlations between CS₅₀/CTave and CS₃₀₋₆₀ integrated value/ICT. FIG. 3A corresponds to the chemically strengthened glass of the first embodiment described above, and FIG. 3B corresponds to the chemically strengthened glass of the second embodiment described above.

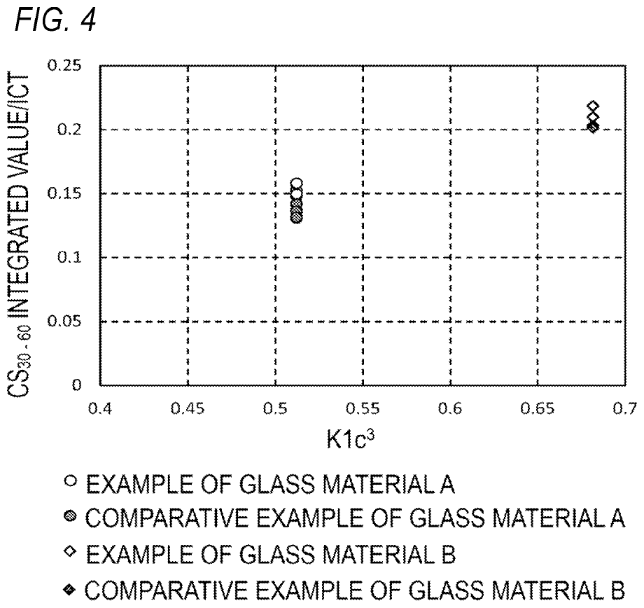

FIG. 4 is a diagram showing a correlation between CS₃₀₋₆₀ integrated value/ICT and K1c³. In FIG. 3A and FIG. 4, “EXAMPLE OF GLASS MATERIAL A” is a result of plotting Examples 1 to 4, and “COMPARATIVE EXAMPLE OF GLASS MATERIAL A” is a result of plotting Examples 11 to 14. In FIG. 3B and FIG. 4, “EXAMPLE OF GLASS MATERIAL B” is a result of plotting Examples 17 and 18, and “COMPARATIVE EXAMPLE OF GLASS MATERIAL B” is a result of plotting Examples 21 and 22.

[set Drop Strength Test]

A drop strength test was performed for Examples 1 to 24, and each of glass samples of 120 mm×60 mm×0.7 mm was fitted into a structural body whose size, mass and stiffness were adjusted to those of common, currently used smartphones to simulate a smartphone, and a resulting sample structure was freely fallen onto a SiC sandpaper of #180. If the sample structure was not broken when it was dropped from a drop height of 5 cm, it was dropped again from a height that was 5 cm higher than the preceding height, and this act was repeated until the sample structure was broken and a height at which the sample structure was broken for the first time was the drop height. Tables 1 and 2 show results of average break heights when 20 pieces for each example were subjected to the drop test as an “average set drop strength”.

TABLE 1

| No. | | | 1 | 2 | 3 | 4 | 5 | |
|---|---|---|---|---|---|---|---|---|
| Glass material | | | A | A | A | A | A | |
| Plate thickness | | mm | 0.7 | 0.7 | 0.7 | 0.7 | 0.6 | |
| CTA | | | 66.0 | 66.0 | 66.0 | 66.0 | 67.5 | |
| First ion | Molten salt | Mass % | KNO₃ 60 + | KNO₃ 60 + | NaNO₃ 100 | NaNO₃100 | KNO₃ 60 + | |
| exchange | composition | | NaNO₃ 40 | NaNO₃ 40 | | | NaNO₃ 40 | |
| | Contact | ° C. | 420 | 420 | 420 | 420 | 410 | |
| | temperature | | | | | | | |
| | Contact time | | 80 min | 70 min | 100 min | 90 min | 180 min | |
| | CTave | MPa | 68.28 | 66.32 | 76.71 | 75.02 | 72.13 | |
| | CTave after first ion | | Exceed CTA | Exceed CTA | Exceed CTA | Exceed CTA | Exceed CTA | |
| | exchange | | value | value | value | value | value | |
| Second ion | Molten salt | Mass % | KNO₃ 90 + | KNO₃ 99.2 + | KNO₃ 99.6 + | KNO₃ 99.7 + | KNO₃ 99.3 + | |
| exchange | composition | | LiNO₃ 1 + | LiNO₃ 0.8 | LiNO₃ 0.4 | LiNO₃ 0.3 | LiNO₃ 0.6 + | |
| | | | K₂CO₃ 0.5 + | | | | LiNO₃ 1 | |
| | | | silica gel 0.5 | | | | | |
| | Contact | ° C. | 410 | 420 | 400 | 400 | 390 | |
| | temperature | | | | | | | |
| | Contact time | | 20 min | 20 min | 60 min | 60 min | 60 min | |
| CS₀ | | MPa | 783 | 851 | 843 | 854 | 906 | |
| CS₅₀ | | MPa | 130 | 123 | 132 | 126 | 99 | |
| CS₉₀ | | MPa | 44 | 38 | 57 | 48 | 20 | |
| CTave | | MPa | 61.4 | 58.1 | 62.4 | 61.1 | 66.8 | |
| ICT | | Pa · m | 28612 | 27550 | 27420 | 27728 | 24000 | |
| CS₅₀/CTave | | Pa · m | 2.12 | 2.11 | 2.12 | 2.05 | 1.48 | |
| CS₅₀/CS₀ | | | 0.166 | 0.145 | 0.157 | 0.148 | 0.109 | |
| K1c | | | 0.80 | 0.80 | 0.80 | 0.80 | 0.80 | |
| CS₅₀/K1c | | | 162.5 | 153.8 | 165.0 | 157.5 | 123.8 | |
| CS₃₀₋₆₀ integrated value | | Pa · m | 4361 | 4087 | 4331 | 4150 | 3510 | |
| CS₃₀₋₆₀ integrated value/ICT | | | 0.152 | 0.148 | 0.158 | 0.150 | 0.146 | |
| CS₃₀₋₆₀ integrated value/ICT/t | | | 0.218 | 0.212 | 0.226 | 0.214 | 0.244 | |
| DOL-tail | | μm | 3 | 3 | 3.1 | 3.1 | 3.5 | |
| Average set drop strength | | cm | 71 | 67 | 72 | 69 | 55 | |
| No. | | | 6 | 7 | 8 | 9 | 10 | |
| Glass material | | | A | A | A | A | A | |
| Plate thickness | | mm | 0.6 | 0.6 | 0.5 | 0.5 | 0.5 | |
| CTA | | | 67.5 | 67.5 | 75.6 | 75.6 | 75.6 | |
| First ion | Molten salt | Mass % | KNO₃ 60 + | KNO₃ 60 + | KNO₃ 60 + | KNO₃ 60 + | KNO₃ 60 + | |
| exchange | composition | | NaNO₃ 40 | NaNO₃ 40 | NaNO₃ 40 | NaNO₃ 40 | NaNO₃ 40 | |
| | Contact | ° C. | 410 | 410 | 410 | 410 | 410 | |
| | temperature | | | | | | | |
| | Contact time | | 180 min | 195 min | 180 min | 180 min | 195 min | |
| | CTave | MPa | 72.13 | 74.60 | 81.30 | 81.30 | 82.30 | |
| | CTave after first ion | | Exceed CTA | Exceed CTA | Exceed CTA | Exceed CTA | Exceed CTA | |
| | exchange | | value | value | value | value | value | |
| Second ion | Molten salt | Mass % | KNO₃ 99.2 + | KNO₃ 99.2 + | KNO₃ 99.3 + | KNO₃ 99.2 + | KNO₃ 99.2 + | |
| exchange | composition | | NaNO₃ 0.6 + | NaNO₃ 0.6 + | NaNO₃ 0.6 + | NaNO₃ 0.6 + | NaNO₃ 0.6 + | |
| | | | LiNO₃ 0.2 | LiNO₃ 0.2 | LiNO₃ 0.1 | LiNO₃ 0.2 | LiNO₃ 0.2 | |
| | Contact | ° C. | 390 | 390 | 390 | 390 | 390 | |
| | temperature | | | | | | | |
| | Contact time | | 60 min | 60 min | 60 min | 60 min | 60 min | |
| CS₀ | | MPa | 836 | 826 | 877 | 794 | 810 | |
| CS₅₀ | | MPa | 102 | 104 | 87 | 93 | 97 | |
| CS₉₀ | | MPa | 17 | 18 | 11 | 13.5 | 6 | |
| CTave | | MPa | 65.6 | 67.2 | 70.7 | 70.0 | 72.1 | |
| ICT | | Pa · m | 25000 | 24500 | 22192 | 20878 | 21100 | |
| CS₅₀/CTave | | Pa · m | 1.55 | 1.55 | 1.23 | 1.33 | 1.35 | |
| CS₅₀/CS₀ | | | 0.122 | 0.126 | 0.099 | 0.117 | 0.120 | |
| K1c | | | 0.80 | 0.80 | 0.80 | 0.80 | 0.80 | |
| CS₅₀/K1c | | | 127.5 | 130.0 | 108.8 | 116.3 | 121.3 | |
| CS₃₀₋₆₀ integrated value | | Pa · m | 3650 | 3600 | 3350 | 3187 | 3320 | |
| CS₃₀₋₆₀ integrated value/ICT | | | 0.146 | 0.147 | 0.151 | 0.153 | 0.157 | |
| CS₃₀₋₆₀ integrated value/ICT/t | | | 0.243 | 0.245 | 0.302 | 0.305 | 0.315 | |
| DOL-tail | | μm | 3.5 | 3.5 | 3.6 | 3.6 | 3.6 | |
| Average set drop strength | | cm | 57 | 58 | 50 | 53 | 54 | |
| No. | | | 11 | 12 | 13 | 14 | 15 | 16 |
| Glass material | | | A | A | A | A | A | A |
| Plate thickness | | mm | 0.7 | 0.7 | 0.7 | 0.7 | 0.6 | 0.5 |
| CTA | | | 66.0 | 66.0 | 66.0 | 66.0 | 67.5 | 75.6 |
| First ion | Molten salt | Mass % | KNO₃ 60 + | KNO₃ 98.4 + | NaNO₃ | NaNO₃100 | NaNO₃ | NaNO₃100 |
| exchange | composition | | NaNO₃ 40 | LiNO₃ 1.6 | 100 | | 100 | |
| | Contact | ° C. | 420 | 420 | 380 | 380 | 410 | 410 |
| | temperature | | | | | | | |
| | Contact time | | 65 min | 105 min | 150 min | 90 min | 150 min | 150 min |
| | CTave | MPa | 65.93 | 64.50 | 64.15 | 50.96 | 64.70 | 74.70 |
| | CTave after first | | Less than | Less than | Less than | Less than | Less than | CTA value |
| | ion exchange | | CTA value | CTA value | CTA value | CTA value | CTA value | Less than |
| Second ion | Molten salt | Mass % | KNO₃ 99.2 + | KNO₃ 99.5 + | KNO₃ 100 | KNO₃ 96 + | KNO₃ 99 + | KNO₃ 99 + |
| exchange | composition | | NaNO₃ 0.6 + | NaNO₃ 0.3 + | | NaNO₃ 4 | NaNO₃ 1 | NaNO₃ 1 |
| | | | LiNO₃ 0.2 | LiNO₃ 0.2 | | | | |
| | Contact | ° C. | 420 | 400 | 400 | 425 | 440 | 440 |
| | temperature | | | | | | | |

| | | | | | | |
|---|---|---|---|---|---|---|
| Contact time | 30 min | 70 min | 90 min | 60 min | 60 min | 60 min |

| CS₀ | MPa | 921 | 906 | 1200 | 926 | 920 | 885 |
|---|---|---|---|---|---|---|---|
| CS₅₀ | MPa | 119 | 106 | 117 | 119 | 85 | 65.6 |
| CS₉₀ | MPa | 38 | 47 | 41 | 33 | 25 | 4 |
| CTave | MPa | 60.6 | 59.5 | 62.9 | 64.7 | 61.2 | 59.8 |
| ICT | Pa · m | 28552 | 26364 | 29066 | 30896 | 23218 | 18738 |
| CS₅₀/CTave | Pa · m | 1.96 | 1.78 | 1.86 | 1.84 | 1.39 | 1.10 |
| CS₅₀/CS₀ | | 0.129 | 0.117 | 0.098 | 0.129 | 0.092 | 0.074 |
| K1c | | 0.80 | 0.80 | 0.80 | 0.80 | 0.80 | 0.80 |
| CS₅₀/K1c | | 148.8 | 132.5 | 146.3 | 148.8 | 106.3 | 82.0 |
| CS₃₀₋₆₀ integrated value | Pa · m | 4051 | 3453 | 3965 | 4061 | 2845 | 2297 |
| CS₃₀₋₆₀ integrated value/ICT | | 0.142 | 0.131 | 0.136 | 0.131 | 0.123 | 0.123 |
| CS₃₀₋₆₀ integrated value/ICT/t | | 0.203 | 0.187 | 0.195 | 0.188 | 0.204 | 0.245 |
| DOL-tail | μm | 3.5 | 3.1 | 3.4 | 4.4 | 6.1 | 6.2 |
| Average set drop strength | cm | 65 | 59 | 64 | 65 | 49 | 40 |

TABLE 2

| No. | | | 17 | 18 | 19 | 20 |
|---|---|---|---|---|---|---|
| Glass material | | | B | B | B | B |
| Plate thickness | | mm | 0.7 | 0.7 | 0.6 | 0.5 |
| CTA | | | 96.4 | 96.4 | 100 | 112 |
| First ion | Molten salt | Mass % | NaNO₃ 100 | NaNO₃ | NaNO₃ 100 | NaNO₃ 100 |
| exchange | composition | | | 99.6 + | | |
| | | | | LiNO₃ 0.4 | | |
| | Contact | ° C. | 390 | 390 | 390 | 390 |
| | temperature | | | | | |
| | Contact time | | 210 min | 300 min | 150 min | 150 min |
| | CTave | MPa | 96.5 | 100.0 | 110.0 | 125.0 |
| | CTave after first ion | | Exceed CTA | Exceed CTA | Exceed CTA | Exceed CTA |
| | exchange | | value | value | value | value |
| Second ion | Molten salt | Mass % | KNO₃ 100 | KNO₃ | KNO₃ | KNO₃ |
| exchange | composition | | | 99.8 + | 99.8 + | 99.8 + |
| | | | | LiNO₃ 0.2 | LiNO₃ 0.2 | LiNO₃ 0.2 |
| | Contact | ° C. | 410 | 410 | 410 | 410 |
| | temperature | | | | | |
| | Contact time | | 60 min | 60 min | 60 min | 60 min |
| CS₀ | | MPa | — | — | — | — |
| CS₅₀ | | MPa | 233 | 217 | 202 | 186 |
| CS₉₀ | | MPa | 59 | 83 | 40 | 21 |
| CTave | | MPa | 83 | 71 | 98 | 111 |
| ICT | | Pa · m | 40202 | 33636 | 33000 | 30000 |
| CS₅₀/CTave | | Pa · m | 2.81 | 3.06 | 2.06 | 1.68 |
| K1c | | | 0.88 | 0.88 | 0.88 | 0.88 |
| CS₅₀/K1c | | | 265 | 247 | 230 | 211 |
| CS₃₀₋₆₀ integrated value | | Pa · m | 8786 | 7059 | 6800 | 6000 |
| CS₃₀₋₆₀ integrated value/ICT | | | 0.219 | 0.210 | 0.206 | 0.200 |
| CS₃₀₋₆₀ integrated value/ICT/t | | | 0.312 | 0.300 | 0.343 | 0.400 |
| DOL-tail | | μm | — | — | — | — |
| Average set drop strength | | μm | 135 | 125 | 116 | 107 |
| No. | | | 21 | 22 | 23 | 24 |
| Glass material | | | B | B | B | B |
| Plate thickness | | mm | 0.7 | 0.7 | 0.6 | 0.5 |
| CTA | | | 96.4 | 0.7 | 100 | 112 |
| First ion | Molten salt | Mass % | NaNO₃ 100 | NaNO₃ 100 | NaNO₃ 100 | NaNO₃ 100 |
| exchange | composition | | | | | |
| | Contact | ° C. | 390 | 390 | 390 | 390 |
| | temperature | | | | | |
| | Contact time | | 150 min | 180 min | 120 min | 120 min |
| | CTave | MPa | 80.9 | 88.7 | 110.0 | 125.0 |
| | CTave after first ion | | Less than | Less than | Less than | Less than |
| | exchange | | CTA value | CTA value | CTA value | CTA value |
| Second ion | Molten salt | Mass % | KNO₃ 100 | KNO₃ 100 | KNO₃ 100 | KNO₃ 100 |
| exchange | composition | | | | | |
| | Contact | ° C. | 410 | 410 | 410 | 410 |
| | temperature | | | | | |

| | | | | |
|---|---|---|---|---|
| Contact time | 60 min | 60 min | 60 min | 60 min |

| CS₀ | MPa | — | — | — | — |
|---|---|---|---|---|---|
| CS₅₀ | MPa | 180 | 200 | 154 | 136 |
| CS₉₀ | MPa | 35 | 49 | 17 | −7 |
| CTave | MPa | 70 | 78 | 77 | 88 |
| ICT | Pa · m | 35474 | 38702 | 30000 | 28624 |
| CS₅₀/CTave | Pa · m | 2.57 | 2.56 | 2.00 | 1.55 |
| K1c | | 0.88 | 0.88 | 0.88 | 0.88 |
| CS₅₀/K1c | | 205 | 227 | 175 | 155 |
| CS₃₀₋₆₀ integrated value | Pa · m | 7204 | 7795 | 4800 | 4000 |
| CS₃₀₋₆₀ integrated value/ICT | | 0.203 | 0.201 | 0.160 | 0.140 |
| CS₃₀₋₆₀ integrated value/ICT/t | | 0.290 | 0.288 | 0.267 | 0.279 |
| DOL-tail | μm | — | — | — | — |
| Average set drop strength | μm | 103 | 115 | 89 | 79 |

TABLE 3

| | | Example 3 | | | |
|---|---|---|---|---|---|
| Ion exchange | | | Second | Example 13 | |
| Molten salt | | First | KNO₃ 99.6 + | First | Second |
| composition | Mass % | NaNO₃ 100% | LiNO₃ 0.4 | NaNO₃ 100% | KNO₃ 100% |
| CS₅₀ | MPa | 169 | 132 | 129 | 117 |
| CS₉₀ | MPa | 25 | 57 | −8 | 41 |
| DOLzero | μm | 101 | 131 | 87 | 119 |
| CTmax | MPa | 89 | 83 | 71 | 81 |
| ICT | MPa | 19302 | 13710 | 16903 | 14533 |
| CTave | MPa | 77 | 62 | 64 | 63 |

| | | | | |
|---|---|---|---|---|
| CS₅₀/CTave | 2.18 | 2.12 | 2.01 | 1.86 |

As shown in Tables 1 to 3, in Examples 1 to 10 and 17 to 20, which are working examples, CTave value after the first ion exchange treatment exceeds CTA value, and an excellent set drop strength is exhibited as compared with the comparative examples.

As shown in Table 3 and FIGS. 2A and 2B, the stress profile of the chemically strengthened glass obtained by the manufacturing method of the present embodiment, as compared with a chemically strengthened glass obtained by a two-stage strengthening in the related art showing the same compressive stress layer depth, can be formed with a higher surface layer compressive stress (CS in an area having a depth of greater than 50 lam deep from the surface) while having a comparable average value CTave of the tensile stress.

As shown FIGS. 3A and 3B, for both the first embodiment and the second embodiment, the working examples exhibited higher CS₅₀/CTave and CS₃₀₋₆₀ integrated value/ICT values and superior stress characteristics than the comparative examples.

As shown in FIG. 4, in the case where the glass material A or B was used, it was found that the examples in which CS₃₀₋₆₀ integrated value/ICT satisfies the following Inequation (4) had a higher CS₅₀ value and an excellent set drop strength than the comparative examples. The right side of the following lnequation (4) indicates threshold values of the working examples and the comparative examples in FIG. 4.

(CS₃₀₋₆₀ integrated value/ICT)>0.29×y³+0.00086×ln(y²)+0.0013×y−0.0213×t Inequation (4)

In Inequation (4), y=K1c.

Although the present invention has been described in detail with reference to specific embodiments, it will be apparent to those skilled in the art that various changes and modifications can be made without departing from the spirit and scope of the present invention. The present application is based on the Japanese patent application (Japanese patent application No. 2021-030726) filed on Feb. 26, 2021 and the Japanese patent application (Japanese patent application No. 2022-008178) filed on Jan. 21, 2022, contents of which are incorporated by reference herein. All references cited herein are incorporated herein entirety.

1. A chemically strengthened glass manufacturing method for obtaining a chemically strengthened glass by performing an ion exchange treatment on a glass for chemical strengthening having a CTA value of x (MPa) obtained by Equation (1) shown below, the method comprising:
a first ion exchange treatment of bringing a first molten salt composition into contact with the glass for chemical strengthening so that a CTave value, which is obtained by Equation (2) shown below, of the glass for chemical strengthening exceeds x (MPa); and
a second ion exchange treatment, after the first ion exchange treatment, of bringing the glass for chemical strengthening into contact with a second molten salt composition having a component ratio different from a composition ratio of the first molten salt composition so that the CTave value of the glass for chemical strengthening is less than x (MPa),
[Eq. 1]
CTA=317.93×K1c/\sqrt{t}+228.5×t−398 Equation (1) in which,
t represents a plate thickness (μm), and
K1c represents a fracture toughness value (MPa·m^{1/2}), and
CTave=ICT/L_{cr} Equation (2) in which,
ICT represents an integrated value (Pa·m) of tensile stress, and
L_{CT} represents a plate thickness direction length (μm) of a tensile stress area.

2. The chemically strengthened glass manufacturing method according to claim 1, wherein
the second molten salt composition further comprises lithium nitrate.

3. The chemically strengthened glass manufacturing method according to claim 1, wherein
at least one of the first ion exchange treatment and the second ion exchange treatment is an ion exchange treatment having two or more stages.

4. The chemically strengthened glass manufacturing method according to claim 1, wherein
the glass for chemical strengthening comprises, as represented by mol % based on oxides,
52% to 75% of SiO₂,
8% to 20% of Al₂O₃, and
5% to 16% of Li₂O.

5. The chemically strengthened glass manufacturing method according to claim 1, wherein
the glass for chemical strengthening comprises, as represented by mol % based on oxides,
40% to 75% of SiO₂,
1% to 20% of Al₂O₃, and
5% to 35% of Li₂O.

6. A chemically strengthened glass having a Z value represented by Equation (3) shown below that satisfies Inequation (4) shown below,
Z=(CS₃₀₋₆₀ integrated value/ICT) Equation (3),
Z>0.29×y³+0.00086×ln(y²)+0.0013×y−0.0213×t Inequation (4),
in Inequation (4), y=K1c, and
in Equation (3),
CS₃₀₋₆₀ integrated value represents an integrated value (Pa·m) of a compressive stress CS at a depth of 30 μm to 60 μm from a surface,
ICT represents an integrated value (Pa·m) of a tensile stress,
K1c represents a fracture toughness value (MPa·m^{1/2}), and
t represents a plate thickness (mm).

7. The chemically strengthened glass according to claim 6, wherein
when the plate thickness is 0.7 mm, a value obtained by dividing the integrated value (Pa·m) of the compressive stress CS at the depth of 30 μm to 60 μm from the surface by the integrated value ICT (Pa·m) of the tensile stress is 0.145 or more, and
a base composition of the chemically strengthened glass comprises, as represented by mol % based on oxides,
52% to 75% of SiO₂,
8% to 20% of Al₂O₃, and
5% to 16% of Li₂O.

8. The chemically strengthened glass according to claim 7, wherein
when the plate thickness is 0.7 mm, a value obtained by dividing a compressive stress CS₅₀ (MPa) at a depth of 50 μm from the surface by the fracture toughness value K1c (MPa·m^{1/2}) is 152 or more.

9. The chemically strengthened glass according to claim 7, wherein
when the plate thickness is 0.7 mm, a value obtained by dividing a compressive stress CS₅₀ (MPa) at a depth of 50 μm from the surface by a surface compressive stress CS₀ (MPa) is 0.140 or more.

10. The chemically strengthened glass according to claim 7, wherein
when the plate thickness is 0.7 mm, a value obtained by dividing a compressive stress CS₅₀ (MPa) at a depth of 50 μm from the surface by a CTave value (MPa) obtained by Equation (2) shown below is 2.0 or more,
CTave=ICT/L_{cr} Equation (2), in which
ICT represents an integrated value (Pa·m) of tensile stress, and
L_{CT} represents a plate thickness direction length (μm) of a tensile stress area.

11. The chemically strengthened glass according to claim 6, wherein
when the plate thickness is 0.7 mm, a value obtained by dividing the integrated value (Pa·m) of the compressive stress CS at the depth of 30 μm to 60 μm from the surface by the integrated value ICT (Pa·m) of the tensile stress is 0.205 or more, and
a base composition of the chemically strengthened glass comprises, as represented by mol % based on oxides,
40% to 75% of SiO₂,
5% to 35% of Li₂O, and
1% to 20% Al₂O₃.

12. The chemically strengthened glass according to claim 10, wherein
when the plate thickness is 0.7 mm, a value obtained by dividing the compressive stress CS₅₀ (MPa) at the depth of 50 μm from the surface by the fracture toughness value K1c (MPa·m^{1/2}) is 240 or more.

13. The chemically strengthened glass according to claim 11, wherein
when the plate thickness is 0.7 mm, a value obtained by dividing a compressive stress CS₅₀ (MPa) at a depth of 50 μm from the surface by a CTave value (MPa) obtained by Equation (2) shown below is 2.6 or more, and
CTave=ICT/L_{cr} Equation (2), in which
ICT represents an integrated value (Pa·m) of tensile stress, and
L_{CT} represents a plate thickness direction length (μm) of a tensile stress area.

14. The chemically strengthened glass according to claim 6, wherein
when the plate thickness is t mm, a value obtained by dividing the integrated value (Pa·m) of the compressive stress CS at the depth of 30 μm to 60 μm from the surface by the integrated value ICT (Pa·m) of the tensile stress is (−0.442×t+0.2) or more, and
a base composition of the chemically strengthened glass comprises, as represented by mol % based on oxides,
52% to 75% of SiO₂,
8% to 20% of Al₂O₃, and
5% to 16% of Li₂O.

15. The chemically strengthened glass according to claim 14, wherein
when the plate thickness is t mm, a CS₅₀/K1c value obtained by dividing a compressive stress CS₅₀ (MPa) at a depth of 50 μm from the surface by the fracture toughness value K1c (MPa·m^{1/2}) is (225×t−25) or more.

16. The chemically strengthened glass according to claim 14, wherein
when the plate thickness is t mm, a CS₅₀/CS₀ value obtained by dividing a compressive stress CS₅₀ (MPa) at a depth of 50 μm from the surface by a surface compressive stress CS₀ (MPa) is (0.25×t−0.05) or more.

17. The chemically strengthened glass according to claim 14, wherein
when the plate thickness is t mm, a CS₅₀/CTave value obtained by dividing a compressive stress CS₅₀ (MPa) at a depth of 50 μm from the surface by a CTave value (MPa) obtained by Equation (2) shown below is (4.3×t−1) or more, and
CTave=ICT/L_{cr} Equation (2), in which
ICT represents an integrated value (Pa·m) of tensile stress, and
L_{CT} represents a plate thickness direction length (μm) of a tensile stress area.

18. The chemically strengthened glass according to claim 6, wherein
when the plate thickness is t mm, a CS₃₀₋₆₀ integrated value/ICT/t value obtained by dividing the integrated value (Pa·m) of the compressive stress CS at the depth of 30 lam to 60 μm from the surface by the integrated value ICT (Pa·m) of the tensile stress is (−0.6×t+0.70) or more, and
a base composition of the chemically strengthened glass comprises, as represented by mol % based on oxides,
40% to 75% of SiO₂,
5% to 35% of Li₂O, and
1% to 20% of Al₂O₃.

19. The chemically strengthened glass according to claim 18, wherein
when the plate thickness is t mm, a CS₅₀/K1c value obtained by dividing a compressive stress CS₅₀ (MPa) at a depth of 50 μm from the surface by the fracture toughness value K1c (MPa·m^{1/2}) is (350×t−15) or more.

20. The chemically strengthened glass according to claim 18, wherein
when the plate thickness is t mm, a CS₅₀/CTave value obtained by dividing a compressive stress CS₅₀ (MPa) at a depth of 50 lam from the surface by a CTave value (MPa) obtained by Equation (2) shown below is (5×t−0.85) or more,
CTave=ICT/L_{cT} Equation (2), in which
ICT represents an integrated value (Pa·m) of tensile stress, and
L_{CT} represents a plate thickness direction length (μm) of a tensile stress area.
